(19) United States
(12) Patent Application Publication
(10) Pub. No.: US 2013/0151888 A1
(43) Pub. Date: Jun. 13, 2013

(54) Avoiding A Ping-Pong Effect On Active-Passive Storage

(71) Applicants: Sukadev Bhattiprolu, Beaverton, OR (US); Venkateswararao Jujjuri, Beaverton, OR (US); Haren Myneni, Tigard, OR (US); Malahal R. Naineni, Tigard, OR (US); Badari Pulavarty, Beaverton, OR (US); Chandra S. Seetharaman, Austin, TX (US); Narasimha N. Sharoff, Beaverton, OR (US)

(72) Inventors: Sukadev Bhattiprolu, Beaverton, OR (US); Venkateswararao Jujjuri, Beaverton, OR (US); Haren Myneni, Tigard, OR (US); Malahal R. Naineni, Tigard, OR (US); Badari Pulavarty, Beaverton, OR (US); Chandra S. Seetharaman, Austin, TX (US); Narasimha N. Sharoff, Beaverton, OR (US)

(73) Assignee: INTERNATIONAL BUSINESS MACHINES CORPORATION, Armonk, NY (US)

(21) Appl. No.: 13/316,595

(22) Filed: Dec. 12, 2011

(51) Int. Cl. G06F 11/16

(52) U.S. Cl. 714/6.3; 714/E11.062

(57) ABSTRACT

A technique for avoiding a ping-pong effect on active-passive paths in a storage system managing one or more logical storage units (LUNs) on behalf of one or more host systems. A first path to the LUNs is designated as an active path and a second path to the LUNs is designated as a passive path. The first path is also designated as a preferred path to the LUNs. In response to a path failure in which a host system cannot access the LUNs on the first path, a failover operation is implemented wherein the second path is designated as the active path and the first path is designated as the passive path. The designation of the first path as the preferred path to the LUNs is not changed. Subsequent failback operations are conditionally inhibited so that only the failover host that initiated the failover is permitted to initiate a failback.

### BACKGROUND

1. Field

The present disclosure relates to intelligent storage systems and methods in which logical storage units (LUNs) are managed for use by host systems that perform data storage input/output (I/O) operations on the LUNs. More particularly, the present disclosure pertains to intelligent storage systems that support active-passive configurations using redundant communication paths from each host system to each LUN.

2. Description of the Prior Art

By way of background, many intelligent storage systems that support redundant communication paths to the same LUN implement active/passive configurations wherein host systems are allowed to access the LUN on only a single path at any given time. This represents the active path whereas the remaining path(s) to the LUN represents passive path(s). Additionally, storage systems may also allow administrators to define preferred (default) paths and non-preferred (non-default) paths to balance the I/O traffic on the storage system controllers. Initially, a preferred path to a LUN is usually selected to be the LUN's active path.

During storage system operations, a path failure may occur in which a host is no longer able to access a LUN on the active path. If the host detects the path failure, it may send a specific failover command (e.g., a SCSI MODE_SELECT command) to the storage system to request that the non-preferred/passive path be designated as the new active path and that the preferred/active path be designated as the new passive path. The storage system will then perform the failover operation in response to the host's failover request. Alternatively, in lieu of sending a specific failover command, the host may simply send an I/O request to the LUN on the passive path. This I/O request will be failed by the storage system but the storage system will then automatically perform the failover operation.

In either of the above situations, it is possible that other hosts can still reach the LUN on the preferred path even though it has been failed over to passive status. For example, the path failure that led to the failover may have been caused by a hardware or software problem in a communication device or link that affects only a single host rather than the storage system controller that handles I/O to the LUN on behalf of all hosts. Other hosts connected to the same controller may thus be able to communicate with the LUN on the preferred path that has now been placed in passive mode. Insofar as such other hosts will usually be programmed to favor using the preferred path as the active path, one or more of such hosts may initiate a failback operation that restores the paths to their default status in which the preferred path is the active path and the non-preferred path is the passive path. The failback operation may then trigger another failover operation from the original host that did a failover if the original path failure condition associated with the preferred path is still present. Thus a repeating cycle of failover/failback operations may be performed to switch between the preferred and non-preferred paths. This path-thrashing activity, which is called the “ping-pong” effect, causes unwanted performance problems.

### SUMMARY

A method, system and computer program product are provided for avoiding a ping-pong effect on active-passive paths in a storage system managing one or more logical storage units (LUNs). A first path to the LUNs is designated as an active path for use by host systems to access the LUNs for data storage input/output (I/O) operations. A second path to the LUNs is designated as a passive path for use by the host systems to access the LUNs for data storage I/O operations. The first path is also designated as a preferred path for use by the host systems to access the LUNs for data storage I/O operations. In response to a path failure on the first path in which a host system cannot access the LUNs on the first path, a failover operation is performed wherein the second path is designated as the active path to the LUNs and the first path is designated as the passive path to the LUNs. Notwithstanding the failover operation, the designation of the first path as the preferred path to the LUNs is not changed. Subsequent failback operations that attempt to redesignate the first path as the active path to the LUNs due to the first path being the preferred path are conditionally inhibited. In particular, a failback operation initiated by a host system that is not the failover host will fail and only the failover host will be permitted to initiate the failback.

### BRIEF DESCRIPTION OF THE DRAWINGS

The foregoing and other features and advantages will be apparent from the following more particular description of an example embodiment, as illustrated in the accompanying Drawings, in which:

FIGS. 1A-1D are functional block diagrams demonstrating a ping-pong effect in a conventional distributed data storage environment in which a pair of host systems interact with an intelligent storage system operating in active-passive storage mode, and in which a path failure leads to repeated failover/failback operations;

FIG. 2 is a functional block diagram showing an example distributed data storage environment which a pair of host systems interact with an improved intelligent storage system that is adapted to avoid the aforementioned ping-pong effect when operating in active-passive storage mode;

FIG. 3 is a flow diagram illustrating example operations that may be performed by the intelligent storage system of FIG. 2 to prevent the aforementioned ping-pong effect;

FIG. 4 is a diagrammatic illustration of an example host port table maintained by the intelligent storage system of FIG. 2, with the host port table being shown in a first state;

FIG. 5 is a diagrammatic illustration of the host port table of FIG. 4, with the host port table being shown in a second state; and

FIG. 6 is a diagrammatic illustration showing example media that may be used to provide a computer program product in accordance with the present disclosure.

### DETAILED DESCRIPTION OF EXAMPLE EMBODIMENT

### Introduction

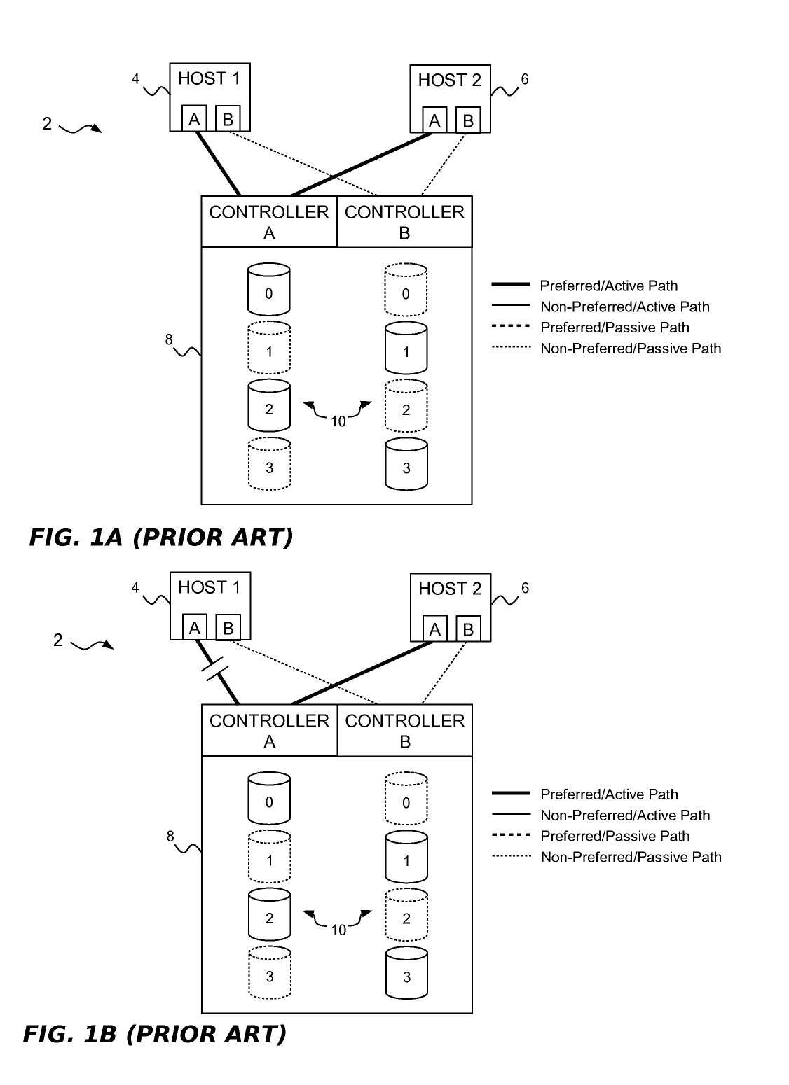

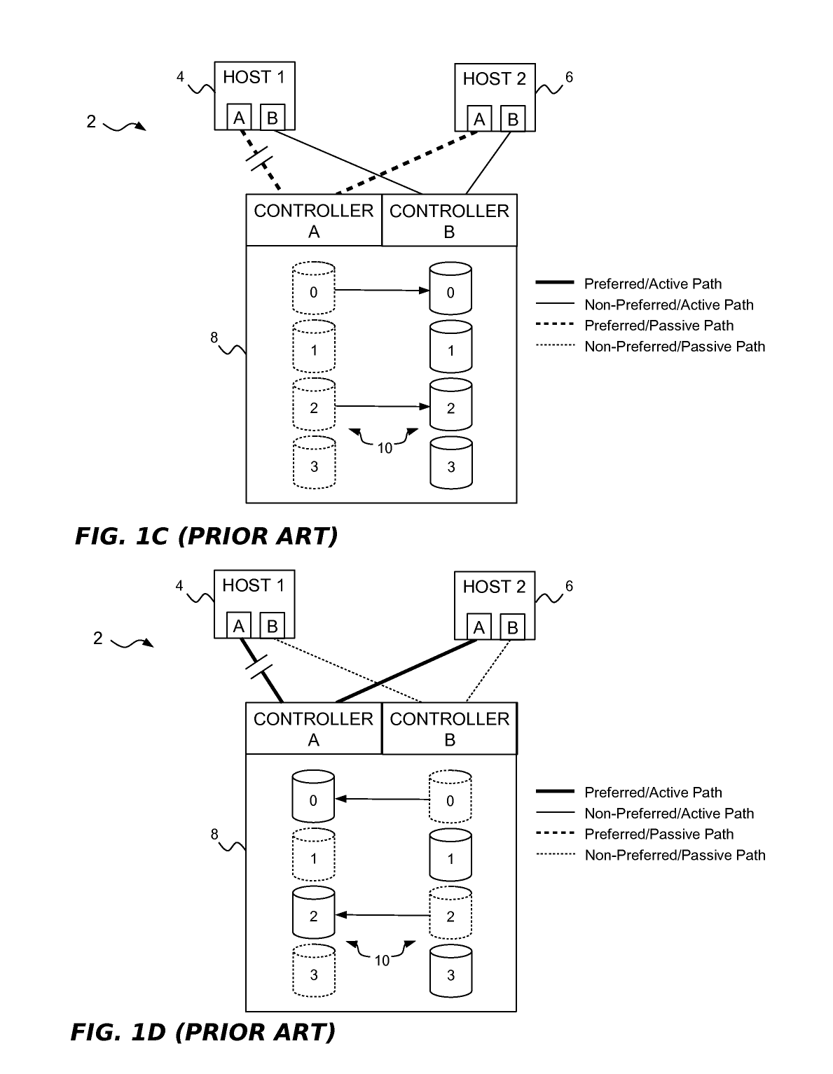

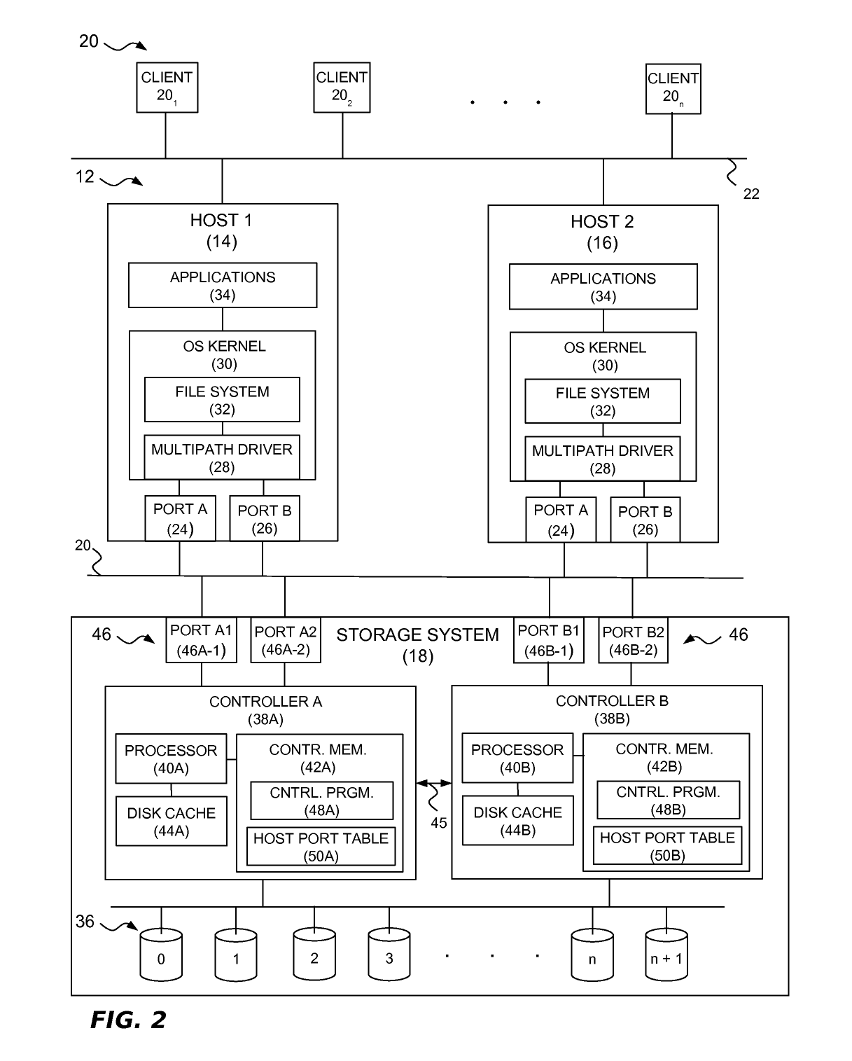

Before describing an example embodiment of the disclosed subject matter, it will be helpful to review the ping-pong phenomenon associated with conventional active-passive storage storage systems in more detail. Turning now to FIGS. 1A-1D, a typical distributed data storage environment 2 is shown in which a pair of host systems 4 (Host 1) and 6 (Host 2) interact with an intelligent storage system 8 operating in active-passive storage mode. FIGS. 1A-1D show the storage environment 2 during various stages of data I/O operations. Host 1 and Host 2 each have two communication ports “A” and “B” that are operatively coupled to corresponding controllers “A” and “B” in the storage system 8. Controller A and Controller B share responsibility for managing data storage input/output (I/O) operations between each of Host 1 and Host 2 and a set of physical data storage volumes 10 within the storage system 8, namely LUN 0, LUN 1, LUN 2 and LUN 3. Controller A is the primary controller for LUN 0 and LUN 2, and a secondary controller for LUN 1 and LUN 3. Controller B is the primary controller for LUN 1 and LUN 3, and a secondary controller for LUN 1 and LUN 2. The solid line paths in FIGS. 1A-1D represent preferred paths and the dashed line paths represent non-preferred paths. The dark color paths in FIGS. 1A-1D represent active paths and the light color paths represent passive paths.

FIG. 1A illustrates an initial condition in which the preferred/active paths from Host 1 and Host 2 to LUN 0 and LUN 2 are through Controller A. The non-preferred/passive paths from Host 1 and Host 2 to LUN 0 and LUN 2 are through Controller B. Similarly, the preferred/active paths from Host 1 and Host 2 to LUN 1 and LUN 3 are through Controller B. The non-preferred/passive paths from Host 1 and Host 2 to LUN 1 and LUN 3 are through Controller A.

FIG. 1B illustrates a subsequent condition in which the preferred/active path that extends from Host 1 through Controller A has failed so that Host 1 is no longer able to access LUN 0 and LUN 2 via the failed path. The preferred/active path from Host 2 through Controller A remains active, such that Host 2 is still able to access LUN 0 and LUN 2 on its preferred/active path.

FIG. 1C illustrates the result of a failover operation in which the active paths from Host 1 and Host 2 to LUN 0 and LUN 2 have been changed to run through Controller B. Although both such paths are now active, they are non-preferred paths. The original preferred paths are now passive paths. The failover operation may be initiated in various ways, depending on the operational configuration of the storage system 8. For example, one common approach is for Host 1 to initiate the failover operation after detecting a path failure by sending a command to Controller B, such as a SCSI MODE_SELECT command. Controller B would then implement the failover operation in response to the command from Host 1. Another commonly used approach is for Host 1 to initiate the failover operation by attempting to communicate with LUN 0 and/or LUN 2 on the path extending through controller B, which is initially non-active. Controller B would detect this communication attempt as a trespass condition, fail the communication request, and then implement the failover operation.

FIG. 1D illustrates the result of a failback operation in which the active/preferred paths from Host 1 and Host 2 to LUN 0 and LUN 2 have been restored. This could result from Host 2 detecting that its preferred path to LUN 0 and LUN 2 through Controller A is no longer active. Insofar as Host 2 is programmed to prefer the path through Controller A over the path through Controller B, it would initiate failback by sending an appropriate command to Controller A to restore the preferred path to active status. Controller A would then implement the failback operation in response to the command from Host 2. Alternatively, Host 2 could initiate failback by attempting to communicate with LUN 0 and/or LUN 2 on the path extending through Controller A. Controller A would detect this communication attempt as a trespass condition, fail the communication request, and then implement the failback operation.

Following the failback operation of FIG. 1D, the failover operation of FIG. 1C could again be performed due a continuance of the path failure experienced by Host 1. A subsequent failback operation would then be performed, followed by another failover operation, and so on. These successive failover/failback operations represent the ping-pong effect described in the “Background” section above. This effect is undesirable because it degrades the performance of the storage environment. For example, as part of the failover operation shown in FIG. 1C, the disk cache information maintained by Controller A for LUN 0 and LUN 2 is transferred to Controller B. Similarly, as part of the failback operation shown in FIG. 1D, the disk cache information maintained by Controller B for LUN 0 and LUN 2 is transferred back to Controller A. Storage operations involving LUN 0 and LUN 2 must be interrupted during these transfer operations. The failover and failback operations also require configuration changes in Host 1 and Host 2, including but not limited to the reconfiguration of volume manager software that may be in use in order to present a logical view of LUN 0 and 2 to client devices (not shown) served by the hosts.

### Example Embodiments

Turning now to the remaining drawing figures, wherein like reference numerals represent like elements in all of the several views, FIG. 2 illustrates a distributed data storage environment 12 that supports an efficient technique for avoiding the above-described ping-pong effect on active-passive storage. The storage environment 12 includes a pair of host systems 14 (Host 1) and 16 (Host 2) that are interconnected to an intelligent storage system 18 by way of a conventional communications infrastructure 20. The communications infrastructure 20 could be implemented in many different ways, including as a set of discrete direct link connections from host to storage system, as an arbitrated loop arrangement, as a switching fabric, as a combination of the foregoing, or in any other suitable manner. Regardless of its implementation details, the communications infrastructure 20 will be hereinafter referred to as a storage area network (SAN).

In the interest of simplicity, the storage environment 12 is shown as having a single storage system 18. In an actual distributed data storage environment, there could be any number of additional storage systems and devices of various type and design. Examples include tape library systems, RAID (Redundant Array of Inexpensive Disks) systems, JBOD (Just a Bunch Of Disks) systems, etc. Likewise, there could be any number of host systems in addition to Host 1 and Host 2. It should also be understood that the individual connection components that may be used to implement embodiments of the SAN 20, such as links, switches, routers, hubs, directors, etc., are not shown in FIG. 2.

In addition to their connectivity to SAN 20, Host 1 and Host 2 may also communicate with a local area network (LAN) 22 (or alternatively a WAN or other type of network) that comprises one or more data processing clients 20, several of which are identified as client systems 20₁, 20₂ . . . 20ₙ. One or more data sets utilized by the client systems 20 are assumed to reside on the storage system 18. Access to these data sets is provided by Host 1 and Host 2, which act as intermediaries between the storage system 18 and the client systems 20.

There are a variety of computer hardware and software components that may be used to implement the various elements that make up the SAN 20, depending on design preferences. The network interconnection components of the SAN 20 may include any number of switches, directors, hubs, bridges, routers, gateways, etc. Such products are conventionally available from a wide array of vendors. Underlying the SAN design will be the selection of a suitable communication and media technology. Most commonly, a fibre channel architecture built using copper or fiber optical media will provide the physical and low level protocol layers. Higher level protocols, such SCSI-FCP (Small Computer System Interface-Fibre Channel Protocol), IPI (Intelligent Peripheral Interface), IP (Internet Protocol), FICON (Fiber Optic CONnection), etc., can be mapped onto the fibre channel protocol stack. Selection of the fibre channel architecture will dictate the choice of devices that will be used to implement the interconnection components that comprise the SAN 20, as well as the network interface hardware and software that connect Host 1, Host 2 and storage system 18 to the SAN. Although less commonly, other low level network protocols, such as Ethernet, could alternatively be used to implement the SAN 20. It should also be pointed out that although the SAN 20 will typically be implemented using wireline communications media, wireless media may potentially also be used for one or more of the communication links.

Host 1 and Host 2 may be implemented as SAN storage manager servers that offer the usual SAN access interfaces to the client systems 20. They can be built from conventional programmable computer platforms that are configured with the hardware and software resources needed to implement the required storage management functions. Example server platforms include the IBM® zSeries®, Power® systems and System x™ products, each of which provides a hardware and operating system platform set, and which can be programmed with higher level SAN server application software, such as one of the IBM® TotalStorage® DS family of Storage Manager systems.

Host 1 and Host 2 each include a pair of network communication ports 24 (Port A) and 26 (Port B) that provide hardware interfaces to the SAN 20. The physical characteristics of Port A and Port B will depend on the physical infrastructure and communication protocols of the SAN 20. If SAN 20 is a fibre channel network, Port A and Port B of each host may be implemented as conventional fibre channel host bus adapters (HBAs). Although not shown, additional SAN communication ports could be provided in each of Host 1 and Host 2 if desired. Ports A and Port B of each host are managed by a multipath driver 28 that may be part of an operating system kernel 30 that includes a file system 32. The operating system kernel 30 will typically support one or more conventional application level programs 34 on behalf of the clients 20 connected to the LAN 22. Examples of such applications include various types of servers, including but not limited to web servers, file servers, database management servers, etc.

The multipath drivers 28 of Host 1 and Host 2 support active-passive mode operations of the storage system 18. Each multipath driver 28 may be implemented to perform conventional multipathing operations such as logging in to the storage system 18, managing the logical paths to the storage system, and presenting a single instance of each storage system LUN to the host file system 32, or to a host logical volume manager (not shown) if the operating system 30 supports logical volume management. As is also conventional, each multipath driver 28 may be implemented to recognize and respond to conditions requiring a storage communication request to be retried, failed, failed over, or failed back.

The storage system 18 may be implemented using any of various intelligent disk array storage system products. By way of example only, the storage system 18 could be implemented using one of the IBM® TotalStorage® DS family of storage servers that utilize RAID technology. In the illustrated embodiment, the storage system 18 comprises an array of disks (not shown) that may be formatted as a RAID, and the RAID may be partitioned into a set of physical storage volumes 36 that may be identified as SCSI LUNs, such as LUN 0, LUN 1, LUN 2, LUN 3 . . . LUN n, LUN n+1. Non-RAID embodiments of the storage system 18 may also be utilized. In that case, each LUN could represent a single disk or a portion of a disk. The storage system 18 includes a pair of controllers 38A (Controller A) and 38B (Controller B) that can both access all of the LUNs 36 in order to manage their data storage input/output (I/O) operations. In other embodiments, additional controllers may be added to the storage system 18 if desired. Controller A and Controller B may be implemented using any suitable type of data processing apparatus that is capable of performing the logic, communication and data caching functions needed to manage the LUNs 36. In the illustrated embodiment, each controller respectively includes a digital processor 40A/40B that is operatively coupled (e.g., via system bus) to a controller memory 42A/42B and to a disk cache memory 44A/44B. A communication link 45 facilitates the transfer of control information and data between Controller A and Controller B.

The processors 40A/40B, the controller memories 42A/42B and the disk caches 44A/44B may be embodied as hardware components of the type commonly found in intelligent disk array storage systems. For example, the processors 40A/40B may be implemented as conventional single-core or multi-core CPU (Central Processing Unit) devices. Although not shown, plural instances of the processors 40A/40B could be provided in each of Controller A and Controller B if desired. Each CPU device embodied by the processors 40A/40B is operable to execute program instruction logic under the control of a software (or firmware) program that may be stored in the controller memory 42A/42B (or elsewhere). The disk cache 44A/44B of each controller 38A/38B is used to cache disk data associated with read/write operations involving the LUNs 36. During active-passive mode operations of the storage system 18, each of Controller A and Controller B will cache disk data for the LUNs that they are assigned to as the primary controller. The controller memory 42A/42B and the disk cache 44A/44B may variously comprise any type of tangible storage medium capable of storing data in computer readable form, including but not limited to, any of various types of random access memory (RAM), various flavors of programmable read-only memory (PROM) (such as flash memory), and other types of primary storage.

The storage system 18 also includes communication ports 46 that provide hardware interfaces to the SAN 20 on behalf of Controller A and Controller B. The physical characteristics of these ports will depend on the physical infrastructure and communication protocols of the SAN 20. A suitable number of ports 46 is provided to support redundant communication wherein Host 1 and Host 2 are each able to communicate with each of Controller A and Controller B. This redundancy is needed to support active-passive mode operation of the storage system 18. In some embodiments, a single port 46 for each of Controller A and Controller B may be all that is needed to support redundant communication, particularly if the SAN 20 implements a network topology. However, in the embodiment of FIG. 2, there are two ports 46A-1 (Port A1) and 46A-2 (Port A2) for Controller A and two ports 46B-1 (Port B1) and 46B-2 (Port B2) for Controller B. This allows the SAN 20 to be implemented with discrete communications links, with direct connections being provided between each Host 1 and Host 2 and each of Controller A and Controller B. Note that additional I/O ports 46 could be provided in order to support redundant connections to additional hosts in the storage environment 2, assuming such hosts were added.

As discussed in the “Introduction” section above, Controller A and Controller B may share responsibility for managing data storage I/O operations between between each of Host 1 and Host 2 and the various LUNs 36. By way of example, Controller A may be the primary controller for all even-numbered LUNs (e.g., LUN 0, LUN 2 . . . LUN n), and the secondary controller for all odd-numbered LUNs (e.g., LUN 1, LUN 3 . . . LUN n+1). Conversely, Controller B may be the primary controller for all odd-numbered LUNs, and the secondary controller for all even-numbered LUNs. Other controller-LUN assignments would also be possible, particularly if additional controllers are added to the storage system 18.

Relative to Host 1, Port A of Host 1 may be configured to communicate with Port A1 of Controller A, and Port B of Host 1 may be configured to communicate with Port B1 of Controller B. In an example embodiment wherein Controller A is the primary controller for all even-numbered LUNs in storage system 18, Host 1 would use its Port A to access even-numbered LUNs on a preferred/active path that extends through Controller A. Port B of Host 1 would provide a non-preferred/passive path to the even-numbered LUNs that extends through Controller B in the event of a path failure on the preferred/active path. For odd-numbered LUNs wherein Controller B is the primary controller, Host 1 would use its Port B to access all such LUNs on a preferred/active path that extends through Controller B. Port A of Host 1 would provide a non-preferred/passive path to the odd-numbered LUNs that extends through Controller A.

Relative to Host 2, Port A of Host 1 may be configured to communicate with Port A2 of Controller A, and Port B of Host 1 may be configured to communicate with Port B2 of Controller B. In an example embodiment wherein Controller A is the primary controller for all even-numbered LUNs in storage system 18, Host 2 would use its Port A to access even-numbered LUNs on a preferred/active path that extends through Controller A. Port B of Host 2 would provide a non-preferred/passive path to the even-numbered LUNs that extends through Controller B. For odd-numbered LUNs wherein Controller B is the primary controller, Host 2 would use its Port B to access all such LUNs on a preferred/active path that extends through Controller B. Port A of Host 2 would provide a non-preferred/passive path to the odd-numbered LUNs that extends through Controller A.

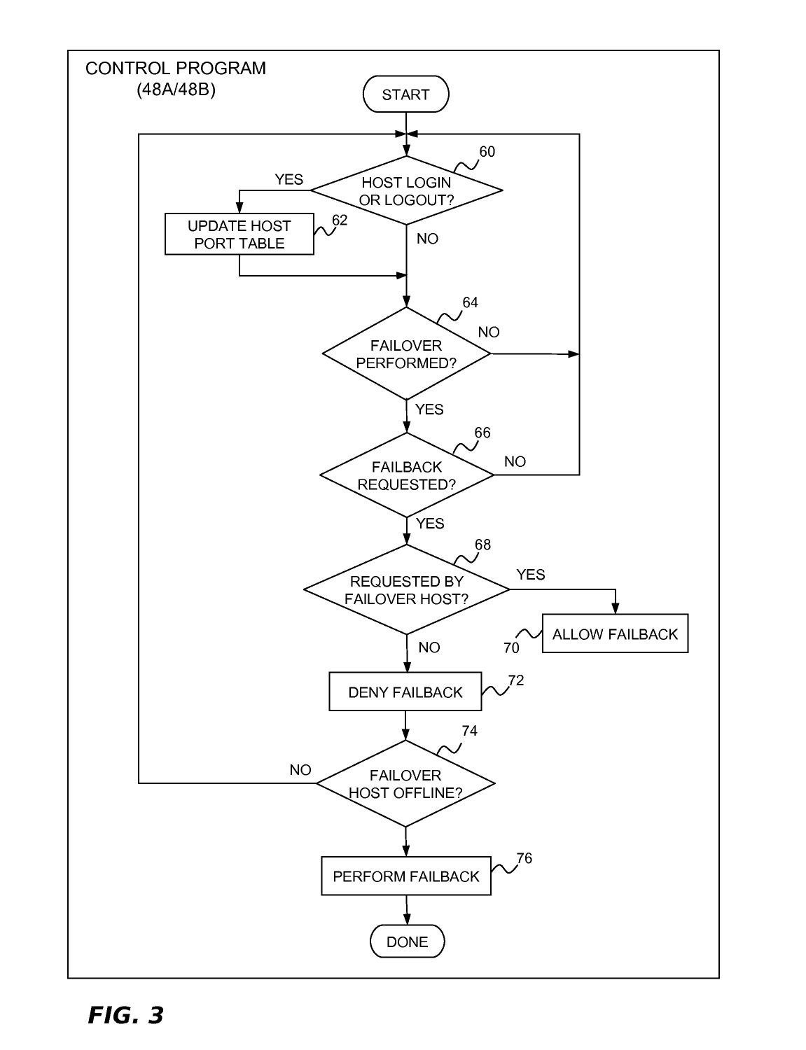

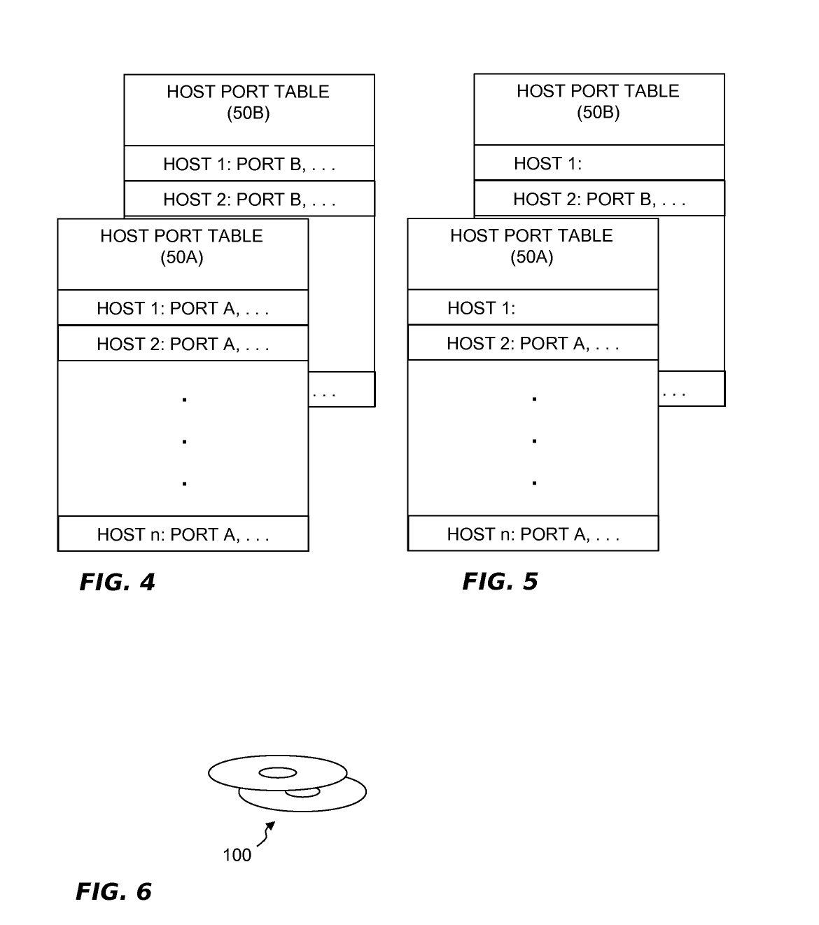

The function of the processors 40A/40B is to implement the various operations of the controllers 38A/38B, including their failover and failback operations when the storage system 18 is in the active-passive storage mode. Control programs 48A/48B that may be stored in the controller memories 42A/42B (or elsewhere) respectively execute on the processors 40A/40B to implement the required control logic. As indicated, the logic implemented by the control programs 48A/48B includes failover/failback operations, which may be performed in the manner described below in connection with FIG. 3. As part of these operations, the control programs 48A/48B respectively maintain and manage host port tables 50A/50B that may also be stored in the controller memories 42A/42B (or elsewhere). Details of the host port tables 50A/50B are described below in connection with FIGS. 4 and 5.

As discussed in the “Introduction” section above, the ping-pong effect caused by repeated failover/failback operations following a path failure is detrimental to efficient storage system operations. For example, assume (according to the example above) that Controller A is the primary controller for all even-numbered LUNs in storage system 18. The preferred/active paths from Host 1 and Host 2 to the even-numbered LUNs will be through Controller A and the non-preferred/passive paths will be through Controller B. A path failure on the preferred/active path between Host 1 and Controller A may result in Host 1 initiating a failover operation in which Controller B assumes responsibility for the even-numbered LUNs. The non-preferred paths from Host 1 and Host 2 to Controller B will be made active and the preferred paths will assume passive status. This allows Host 1 to resume communications with all even-numbered LUNs. However, Host 2 will detect that it is communicating with the even-numbered LUNs on a non-preferred path but has the capability of communicating on the preferred path. If storage system 18 was not adapted to deal with the ping-pong effect, it would allow Host 2 to initiate a failback operation that results in the preferred path from Host 1 and Host 2 to Controller A being restored to active status. This would be optimal for Host 2 but would disrupt the communications of Host 1, assuming the failure condition on its preferred/active path to Controller A still exists. Host 1 would thus reinitiate a failover operation, which would be followed by Host 2 reinitiating a failback operation, and so on.

The foregoing ping-pong problem may be solved by programming Controller A and Controller B to enforce conditions on the ability of Host 1 and Host 2 to initiate a failback operation, to track the port status of the host that initiated the failover operation, and by allowing the controllers themselves to initiate a failback operation based on such status. In particular, Controller A and Controller B may be programmed to only allow a failback operation to be performed by a host that previously initiated a corresponding failover operation (hereinafter referred to as the “failover host”). For example, if the failover host notices that the path failure has been resolved, it may initiate a failback operation to restore the preferred path to active status. This failback operation satisfies the condition imposed by the controller logic, and will be permitted. Other hosts that have connectivity to both the preferred path and the non-preferred path to a LUN will not be permitted to initiate a failback operation. In some embodiments, such other hosts may be denied the right to initiate a failback operation even if they only have connectivity to a LUN via the preferred path, such that the failback-attempting host is effectively cutoff from the LUN. In that situation, it may be more efficient to require the client systems 20 to access the LUN through some other host than to allow ping-ponging.

Controller A and Controller B may be further programmed to monitor the port status of the failover host to determine if it is still online. If all of the ports of the failover host have logged out or other otherwise disconnected from the storage system 18, the controller itself may initiate a failback operation. As part of the controller-initiated failback operation, the controller may first check to see if other hosts will be cutoff, and if so, may refrain from performing the operation. Alternatively, the controller may proceed with failback without regard to the host(s) being cutoff.

The foregoing logic of Controller A and Controller B may be implemented by each controller's respective control program 48A/48B. FIG. 3 illustrates example operations that may be performed by each control program 48A/48B to implement such logic on behalf of its respective controller. In order to simplify the discussion, the operations of FIG. 3 are described from the perspective of control program 48A running on Controller A. However, it will understood that the same operations are performed by control program 48B running on Controller B.

In blocks 60 and 62 of FIG. 3, control program 48A updates the host port table 50A of Controller A in response to either Port A or Port B of Host 1 or Host 2 performing a port login or logout operation. An example implementation of host port table 50A is shown in FIG. 4, with host port table 50B also being depicted to show that it may be structured similarly to host port table 50A. According to the illustrated embodiment, host port table 50A maintains a set of per-host entries. Each host's entry list the ports of that host that are currently logged in and communicating with Controller A. FIG. 4 shows the state of the host port table 50A when Port A/Port B of Host 1 and Port A/Port B of Host 2 are each logged in. FIG. 4 also shows that host port table 50A may store port login information for additional hosts that may be present in the storage environment 12 (e.g., up to Host n).

Following block 62 of FIG. 3, or if no new port login or logout has occurred, control program 48A consults state information conventionally maintained by Controller A (such as a log file) to determine whether a failover operation has been performed that resulted in Controller A being designated as a secondary controller for one or more LUNs 36. As described in the “Introduction” section above, such a failover operation may be performed in response to a host detecting a path failure on its preferred/active path to Controller A, and then initiating the failover by issuing an appropriate command (such as a SCSI MODE_SELECT command) to Controller B, which handles the non-preferred/passive path. Controller B would then implement the failover and become the primary controller for the LUNs previously handled by Controller A (with Controller A being assigned secondary controller status). In other embodiments, a failover operation may be performed in response to a host detecting a path failure on its preferred/active path to Controller A, and then initiating the failover by attempting to communicate with a LUN on the non-preferred/passive path that extends through Controller B. In such an embodiment, Controller B would detect such communication and automatically implement the failover operation.

If block 64 determines that a failover operation has not been performed, processing returns to block 60 insofar as there would be no possibility of a failback operation being performed in that case. On the other hand, if block 64 determines that a failover operation has been performed, processing proceeds to block 66 and control program 48A tests whether a failback operation has been requested by any host. If not, nothing more needs to be done and processing returns to block 60. As described in the “Introduction” section above, a host may request a failback operation by issuing an appropriate command (such as a SCSI MODE_SELECT command) to Controller A, which is on the preferred path that was placed in a passive state by the previous failover operation. In other embodiments, the host may request a failback operation by attempting to resume use of the preferred path that was made passive by the previous failover operation. In such an embodiment, Controller A would detect such communication and automatically implement the failback operation.

If block 66 determines that a failback operation has been requested, the control program 48A consults state information conventionally maintained by Controller A (such as a log file) to determine in block 68 whether the request came from the failover host that initiated the previous failover operation. If true, this means that the failover host has determined that it is once again able to communicate on the preferred path. Insofar as there is no possibility that a failback to that path will trigger a ping-pong effect, the control program 48A may safely implement the failback operation in block 70. Note, however, that control program 48A may first test that all of the remaining hosts are still able to communicate on the preferred path. This may be determined by checking host port table 50A to ensure that each host has at least one port logged into Controller A.

If block 68 determines that the failback request was not made by the failover host, the request is denied in block 72. Thereafter, in block 74, the control program 48A checks whether the failover host has gone offline. This may be determined by checking host port table 50A to see if the failover host has any ports logged into Controller A. FIG. 5 illustrates the condition that host port table 50A might be in if Host 1 had gone offline and none of its ports was logged into Controller A. Note that Controller A may periodically update host port table 50A in any suitable manner to reflect current connectivity conditions. For example, a table update may be performed when a host explicitly logs out (or logs in) one of its ports. In addition, unplanned communication losses with host ports may be detected by periodically polling all known host ports. Ports that do not respond may be removed from host port table 50A or designated as being unreachable. Ports coming back on line may be similarly detected and added back into host port table 50A.

If the failover host is determined to be offline in block 74, Controller A may initiate and perform a failback operation, there being no possibility that this will trigger a ping-pong effect insofar as the failover host is no longer present. Again, however, control program 48A may first test that all of the remaining hosts are still able to communicate on the preferred path. In some embodiments, the failback operation may not be implemented unless all remaining hosts are reachable on the preferred path. In other embodiments, failback may proceed despite one or more hosts being unable to communicate on the preferred path. As part of block 74, the Controller A may also remove any notion of the failover host from its controller memory 42A, so as to allow future failbacks.

Accordingly, a technique has been disclosed for avoiding a ping-pong effect in active-passive storage. It will be appreciated that the foregoing concepts may be variously embodied in any of a data processing system, a machine implemented method, and a computer program product in which programming logic is provided by one or more machine-usable storage media for use in controlling a data processing system to perform the required functions. Example embodiments of a data processing system and machine implemented method were previously described in connection with FIGS. 2-3. With respect to a computer program product, digitally encoded program instructions may be stored on one or more computer-readable data storage media for use in controlling a computer or other digital machine or device to perform the required functions. The program instructions may be embodied as machine language code that is ready for loading and execution by the machine apparatus, or the program instructions may comprise a higher level language that can be assembled, compiled or interpreted into machine language. Example languages include, but are not limited to C, C++, assembly, to name but a few. When implemented on an apparatus comprising a digital processor, the program instructions combine with the processor to provide a particular machine that operates analogously to specific logic circuits, which themselves could be used to implement the disclosed subject matter.

Example data storage media for storing such program instructions are shown by reference numerals 42A/42B (memory) of Controller A and Controller B in FIG. 2. Controller A and Controller B may further use one or more secondary (or tertiary) storage devices (such as one of the LUNs 36) that could store the program instructions between system reboots. A further example of media that may be used to store the program instructions is shown by reference numeral 100 in FIG. 6. The media 100 are illustrated as being portable optical storage disks of the type that are conventionally used for commercial software sales, such as compact disk-read only memory (CD-ROM) disks, compact disk-read/write (CD-R/W) disks, and digital versatile disks (DVDs). Such media can store the program instructions either alone or in conjunction with an operating system or other software product that incorporates the required functionality. The data storage media could also be provided by portable magnetic storage media (such as floppy disks, flash memory sticks, etc.), or magnetic storage media combined with drive systems (e.g. disk drives). As is the case with the memory 48A/48B of FIG. 2, the storage media may be incorporated in data processing apparatus that have integrated random access memory (RAM), read-only memory (ROM) or other semiconductor or solid state memory. More broadly, the storage media could comprise any electronic, magnetic, optical, infrared, semiconductor system or apparatus or device, or any other tangible entity representing a machine, manufacture or composition of matter that can contain, store, communicate, or transport the program instructions for use by or in connection with an instruction execution system, apparatus or device, such as a computer. For all of the above forms of storage media, when the program instructions are loaded into and executed by an instruction execution system, apparatus or device, the resultant programmed system, apparatus or device becomes a particular machine for practicing embodiments of the method(s) and system(s) described herein.

Although various example embodiments have been shown and described, it should be apparent that many variations and alternative embodiments could be implemented in accordance with the disclosure. It is understood, therefore, that the invention is not to be in any way limited except in accordance with the spirit of the appended claims and their equivalents.

What is claimed is:

1. A method for avoiding a ping-pong effect on active-passive paths in a storage system managing one or more logical storage units (LUNs), comprising:
designating a first path to said LUNs as an active path for use by host systems to access said LUNs for data storage input/output (I/O) operations;
designating a second path to said LUNs as a passive path for use by said host systems to access said LUNs for said data storage I/O operations;
designating said first path as a preferred path for use by said host systems to access said LUNs for said data storage I/O operations;
in response a failover host system initiating a failover operation due to a path failure on said first path, performing said failover operation by designating said second path as the active path to said LUNs and designating said first path as the passive path to said LUNs, said failover operation being performed without changing said designation of said first path as the preferred path to said LUNs;
conditionally inhibiting a subsequent failback operation that attempts to redesignate said first path as the active path to said LUNs due to said first path being the preferred path to said LUNs; and
said inhibiting being conditioned on said failback operation being initiated by a host system that is not said failover host, such that only said failover host is permitted to initiate said failback operation.

2. A method in accordance with claim 1, wherein said inhibiting is performed until either said path failure on said first path is corrected or said failover host discontinues communications with said storage system.

3. A method in accordance with claim 2, wherein said inhibiting is performed until said path failure on said first path is corrected and provided that all host systems other than said failover host remain capable of accessing said LUNs on said first path.

4. A method in accordance with claim 2, wherein said inhibiting is performed until said failover host discontinues communications with said storage system and provided that all host systems other than said failover host remain capable of accessing said LUNs on said first path.

5. A method in accordance with claim 2, further including maintaining a host port table that facilitates determining that said failover host has discontinued communications with said storage system.

6. A method in accordance with claim 5, wherein said host port table identifies all host system ports that are communicating with said LUNs.

7. A method in accordance with claim 6, wherein said host port table is populated with host system port identifiers as host system ports initiate communication with said LUNs and wherein said host port table is periodically updated to remove host system ports that are determined not to be communicating with said LUNs.

8. A storage system, comprising:
a plurality of logical storage units (LUNs);
at pair of controllers each being operatively coupled to said LUNs;
at least two communication ports that are each operatively coupled to one of said controllers, said communication ports being operable to communicate with two or more host systems that perform storage operations on said LUNs;
said controllers each having logic circuitry operable to direct said controllers to perform control operations for avoiding a ping-pong effect in which said controllers repeatedly perform failover and failback operations relative to said LUNs, said control operations comprising:
designating a first path to said LUNs as an active path for use by host systems to access said LUNs for data storage input/output (I/O) operations;
designating a second path to said LUNs as a passive path for use by said host systems to access said LUNs for said data storage I/O operations;
designating said first path as a preferred path for use by said host systems to access said LUNs for said data storage I/O operations;
in response a failover host system initiating a failover operation due to a path failure on said first path, performing said failover operation by designating said second path as the active path to said LUNs and designating said first path as the passive path to said LUNs, said failover operation being performed without changing said designation of said first path as the preferred path to said LUNs;
conditionally inhibiting a subsequent failback operation that attempts to redesignate said first path as the active path to said LUNs due to said first path being the preferred path to said LUNs; and
said inhibiting being conditioned on said failback operation being initiated by a host system that is not said failover host, such that only said failover host is permitted to initiate said failback operation.

9. A system in accordance with claim 8, wherein said inhibiting is performed until either said path failure on said first path is corrected or said failover host discontinues communications with said storage system.

10. A system in accordance with claim 9, wherein said inhibiting is performed until said path failure on said first path is corrected and provided that all host systems other than said failover host remain capable of accessing said LUNs on said first path.

11. A system in accordance with claim 9, wherein said inhibiting is performed until said failover host discontinues communications with said storage system and provided that all host systems other than said failover host remain capable of accessing said LUNs on said first path.

12. A system in accordance with claim 9, wherein said operations further include said controllers maintaining a host port table that facilitates determining that said failover host has discontinued communications with said storage system.

13. A system in accordance with claim 12, wherein said host port table identifies all host system ports that are communicating with said LUNs.

14. A system in accordance with claim 13, wherein said host port table is populated with host system port identifiers as host system ports initiate communication with said LUNs and wherein said host port table is periodically updated to remove host system ports that are determined not to be communicating with said LUNs.

15. A computer program product, comprising:
one or more machine-readable storage media;
program instructions provided by said one or more media for programming a data processing controller to perform operations for avoiding a ping-pong effect on active-passive storage in a storage system managing one or more logical storage units (LUNs), comprising:
designating a first path to said LUNs as an active path for use by host systems to access said LUNs for data storage input/output (I/O) operations;
designating a second path to said LUNs as a passive path for use by said host systems to access said LUNs for said data storage I/O operations;
designating said first path as a preferred path for use by said host systems to access said LUNs for said data storage I/O operations;
in response a failover host system initiating a failover operation due to a path failure on said first path, performing said failover operation by designating said second path as the active path to said LUNs and designating said first path as the passive path to said LUNs, said failover operation being performed without changing said designation of said first path as the preferred path to said LUNs;
conditionally inhibiting a subsequent failback operation that attempts to redesignate said first path as the active path to said LUNs due to said first path being the preferred path to said LUNs; and
said inhibiting being conditioned on said failback operation being initiated by a host system that is not said failover host, such that only said failover host is permitted to initiate said failback operation.

16. A computer program product in accordance with claim 15 wherein said inhibiting is performed until either said path failure on said first path is corrected or said failover host discontinues communications with said storage system.

17. A computer program product in accordance with claim 16, wherein said inhibiting is performed until said path failure on said first path is corrected and provided that all host systems other than said failover host remain capable of accessing said LUNs on said first path.

18. A computer program product in accordance with claim 16, wherein said inhibiting is performed until said failover host discontinues communications with said storage system and provided that all host systems other than said failover host remain capable of accessing said LUNs on said first path.

19. A computer program product in accordance with claim 16, wherein said operations further include maintaining a host port table that facilitates determining that said failover host has discontinued communications with said storage system.

20. A computer program product in accordance with claim 19, wherein said host port table identifies all host system ports that are communicating with said LUNs.

21. A computer program product in accordance with claim 20, wherein said host port table is populated with host system port identifiers as host system ports initiate communication with said LUNs and wherein said host port table is periodically updated to remove host system ports that are determined not to be communicating with said LUNs.
